(19) United States
(12) Patent Application Publication
(10) Pub. No.: US 2008/0244329 A1
(43) Pub. Date: Oct. 2, 2008

(54) APPARATUS DIAGNOSING METHOD, APPARATUS DIAGNOSIS MODULE, AND APPARATUS MOUNTED WITH APPARATUS DIAGNOSIS MODULE

(76) Inventors: Kenichi SHINBO, Yokohama (JP); Tadanobu Toba, Yokohama (JP); Katsunori Hirano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/044,003

(22) Filed: Mar. 7, 2008

(30) Foreign Application Priority Data
Mar. 30, 2007 (JP) 2007-090163

(51) Int. Cl. G06F 11/00

(52) U.S. Cl. 714/45; 714/E11.001

(57) ABSTRACT

An apparatus diagnosing method is a method in which, in an apparatus including a control apparatus and a control board for controlling the control apparatus, on the controlling board, an error occurrence at the control apparatus and the control board is detected, an error signal is outputted, sensor data outputted from a sensor acquiring data about operation environments of the control apparatus and the control board is collected, and an environmental factor causing a failure or an error of the control apparatus and the control board is specified based upon the error signal and the sensor data, and the sensor data is collected in association with the error signal when the sensor data is collected.

### CROSS-REFERENCE TO RELATED APPLICATION

The present application claims priority from Japanese Patent Application No. JP 2007-090163 filed on Mar. 30, 2007, the content of which is hereby incorporated by reference into this application.

### TECHNICAL FIELD OF THE INVENTION

The present invention relates to an effective technique applied to an apparatus diagnosing method of collecting data about operation environments of a control apparatus and a control circuit board by sensors, and performing an operation diagnosis for the control apparatus and the control circuit board, and a cause analysis of an error, and the present invention relates to an effective technique applied to an apparatus diagnosis module.

### BACKGROUND OF THE INVENTION

With development of high performance and high functionality of electric equipment devices in recent years, while a plurality of LSIs and CPUs are densely mounted on an electronic circuit board, an operation margin is decreased due to a low-voltage and a high-speed of electronic parts for a semiconductor integrated circuit or the like to be implemented, so that intermittent errors that temporarily cause troubles with a circuit board due to change in the operation environments such as temperature, humidity, vibration, or electromagnetic wave becomes problematic.

Once the intermittent errors occur, for example, the errors may be spontaneously restored, or the errors may be restored only by re-actuation processing, so that in many cases the errors do not simply recur. With self-diagnosing means incorporated into a conventional circuit board or the like, an initial failure during manufacturing or a logical error at a periodical diagnosis can be detected, but the intermittent error that temporarily occurs due to an environmental factor as described above cannot be detected. Therefore, it is difficult to specify an environmental factor adversely affecting the circuit board, so that much time and cost are required for analysis of the intermittent error.

Especially, in an apparatus required for high reliability or a steady operation, such as an elevating machine, since prolongation of a non-operation time results in causing lower service to a user, namely, an apparatus maker may lost its credibility, it is strongly required to provide an apparatus diagnosing method which can analyze the intermittent error of the circuit board caused by the environmental factor to specify a cause of the intermittent error as well as a basic error diagnosis for an apparatus.

As a conventional technique for performing such a failure diagnosis or the like, for example, systems disclosed in Japanese Patent Application Laid-open Publication No. 2000-99484 (Patent Document 1), Japanese Patent Application Laid-open Publication No. 7-234987 (Patent Document 2), or the like has been proposed. By regularly monitoring and collecting data about the operation environment of an apparatus with the sensor, an analysis of a cause of a failure/an error, or the like in the apparatus is performed with using information of an error occurrence and the data about the operation environment.

FIG. 23 is a diagram showing an example of a configuration of an apparatus applying a conventional apparatus diagnosing method. In the apparatus shown in FIG. 23, a plurality of control apparatuses 1 are connected with control boards 2 controlling the respective control apparatuses 1. The apparatus includes a main control board 20 that performs an overall control of the control boards 2, a host computer 4 that sets control data to the main control board 20, collects data, and the like, and sensors 3 that measure data about the operation environments of the apparatus (temperature/humidity, acceleration (vibration), voltage/current, electromagnetic wave, noise, or the like).

Each control board 2 has a control section 5 and an input/output section 8. The main control board 20 includes a diagnosing section 6 as well as the control section 5 and the input/output section 8, and can detect a logical abnormal operation (error) generated during operation of the control apparatus 1 based upon a control signal from the control section 5. On the other hand, sensor data 3a acquired by the sensors 3 is regularly collected by the host computer 4, and it is used for analyzing a state or an environmental factor of the apparatus by the host computer 4 with a software processing when an error occurs. In each sensor 3, by comparing the data to its expected value to make determination, detection of the abnormal value can be performed by the sensor 3 alone.

### SUMMARY OF THE INVENTION

However, in the apparatus diagnosing method by the apparatus shown in FIG. 23, since the analysis of the sensor data 3a when an error occurs is performed by the software processing in the host computer 4, a vast amount of the sensor data 3a proportional to the number of the sensors 3 must regularly be collected in the host computer 4. Also, when the error occurs, it is necessary to extract the sensor data 3a for time periods before and after the error occurrence from the vast amount of the sensor data 3a, and to analyze the extracted sensor data 3a with the software processing. Therefore, if the number of the sensors 3 is increased, an amount of data to be processed is also increased.

Also, like the apparatus shown in FIG. 23, in the case of an apparatus having a configuration in which an error in each control board 2 is detected by the main control board 20, the error at each control apparatus 1 and each control board 2 is detected at the diagnosing section 6 on the upper main control board 20. Therefore, even if the control board 2 on which the error has occurred can be specified, it may be difficult to establish temporal consistency between an error occurrence time and the sensor data 3a collected in real time, so that it is difficult to specify an environmental factor that causes the error.

Concerning detection of an abnormal value based upon the sensor data 3a by the sensor 3 alone, the sensor 3 can detect whether operation status or the operation environment of an apparatus is abnormal or not, but since the abnormal value is not associated with information of the error occurring at each control apparatus 1 or each control board 2, it is difficult to specify the environmental factor which has caused the error.

Accordingly, an object of the present invention is to provide an apparatus diagnosing method and an apparatus diagnosis module in which data about an operational environment corresponding to the intermittent error caused by change in the operational environment of an apparatus is collected by the sensor in association with error information generated in the apparatus, and therefore the environment factor causing the intermittent error can be readily specified.

The above and other objects and novel features of the present invention will be apparent from the description of the present specification and the accompanying drawings.

A representative invention of the inventions disclosed in the present application will be briefly explained below.

An apparatus diagnosing method according to the present invention is a method in which, in an apparatus including a control apparatus and control boards for controlling the control apparatus, on each of the control boards, the error occurrence at the control apparatus and the control board is detected, an error signal is outputted, sensor data outputted from a sensor acquiring data about the operation environments of the control apparatus and the control board are collected, and an environmental factor causing a failure or an error of the control apparatus and the control boards is specified based upon the error signal and the sensor, and the sensor data is collected in association with the error signal when the sensor data is collected.

The present invention can also be applied to an apparatus diagnosis module for specifying the environment factor which has caused a failure or an error at the control apparatus and the control board.

An effect obtained by the representative invention of the inventions disclosed in the present application will be briefly explained below.

According to the present invention, by analyzing collected sensor data in association with a target error corresponding to the error caused by change in the operation environment in an apparatus, the environmental factor which has caused the error can be specified.

In addition, according to the present invention, since the sensor data can be collected only for limited time periods before and after the error occurrence, a small-sized/capacity memory can be adopted as a memory for sensor data collection mounted on each control board in an apparatus. Therefore, it is possible to achieve the reduction in size of the control board and to apply the apparatus diagnosing method to various control boards. Further, the number of the sensors for acquiring data can be increased by memory expansion, so that a detailed analysis of the intermittent error can be made possible for each control board.

### BRIEF DESCRIPTIONS OF THE DRAWINGS

FIG. 1 is a diagram showing an entire configuration of a system according to a first embodiment of the present invention;

FIG. 2 is a diagram showing a configuration of a sensor link section in the system according to the first embodiment of the present invention;

FIG. 3 is a diagram showing a configuration of a delay processing section in the system according to the first embodiment of the present invention;

FIG. 4 is a diagram showing an operation of a log memory and a bit allocation example of data in the system according to the first embodiment of the present invention;

FIG. 5 is a diagram showing an example of timing adjustment in the sensor link section and a storage range of sensor data corresponding to an error signal in the system according to the first embodiment of the present invention;

FIG. 6A is a diagram showing an example of storing sensor data into a log memory in the system according to the first embodiment of the present invention;

FIG. 6B is a diagram showing an example of storing sensor data into a log memory in the system according to the first embodiment of the present invention;

FIG. 6C is a diagram showing an example of storing sensor data into a log memory in the system according to the first embodiment of the present invention;

FIG. 7 is a flowchart representing a flow of an apparatus diagnosing processing in the system according to the first embodiment of the present invention;

FIG. 8 is a diagram showing an entire configuration of a system according to a second embodiment of the present invention;

FIG. 9 is a diagram showing an entire configuration of a system according to a third embodiment of the present invention;

FIG. 10 is a diagram showing an entire configuration of the system according to the third embodiment of the present invention;

FIG. 11 is a diagram showing a configuration of a sensor link section in the system according to the third embodiment of the present invention;

FIG. 12 is a diagram showing an entire configuration of the system according to the third embodiment of the present invention;

FIG. 13 is a diagram showing a configuration of a sensor link section in the system according to the third embodiment of the present invention;

FIG. 14 is a diagram showing an entire configuration of the system according to the third embodiment of the present invention;

FIG. 15 is a diagram showing a configuration of a sensor link section in the system according to the third embodiment of the present invention;

FIG. 16 is a diagram showing a configuration of an error input selecting section in the system according to the third embodiment of the present invention;

FIG. 17 is a diagram showing an entire configuration of the system according to the third embodiment of the present invention;

FIG. 18 is a diagram showing a configuration of a sensor link section in the system according to the third embodiment of the present invention;

FIG. 19 is a diagram showing an example of a configuration of a diagnosing section and a sensor link section in the system according to the third embodiment of the present invention;

FIG. 20A is a diagram showing an outline and a configuration of an apparatus diagnosis module which is a fourth embodiment of the present invention;

FIG. 20B is a diagram showing an outline and a configuration of an apparatus diagnosis module which is a fourth embodiment of the present invention;

FIG. 20C is a diagram showing an outline and a configuration of an apparatus diagnosis module which is a fourth embodiment of the present invention;

FIG. 20D is a diagram showing an outline and a configuration of an apparatus diagnosis module which is a fourth embodiment of the present invention;

FIG. 21 is a diagram showing an example where an apparatus diagnosing method which is a fifth embodiment of the present invention is applied to a remote monitoring-diagnosing system;

FIG. 22 is a diagram showing a display example of collected sensor data at an error occurrence time on a host computer in the remote monitoring and diagnosing system according to the fifth embodiment of the present invention; and

FIG. 23 is a diagram showing an example of an apparatus applied with a conventional apparatus diagnosing method.

### DESCRIPTIONS OF THE PREFERRED EMBODIMENTS

Embodiments of the present invention will be explained in detail below with reference to the drawings. Incidentally, the same sections or portions are denoted by the same reference numerals through all drawings for explaining the embodiments in principle and explanation thereof is omitted.

### First Embodiment

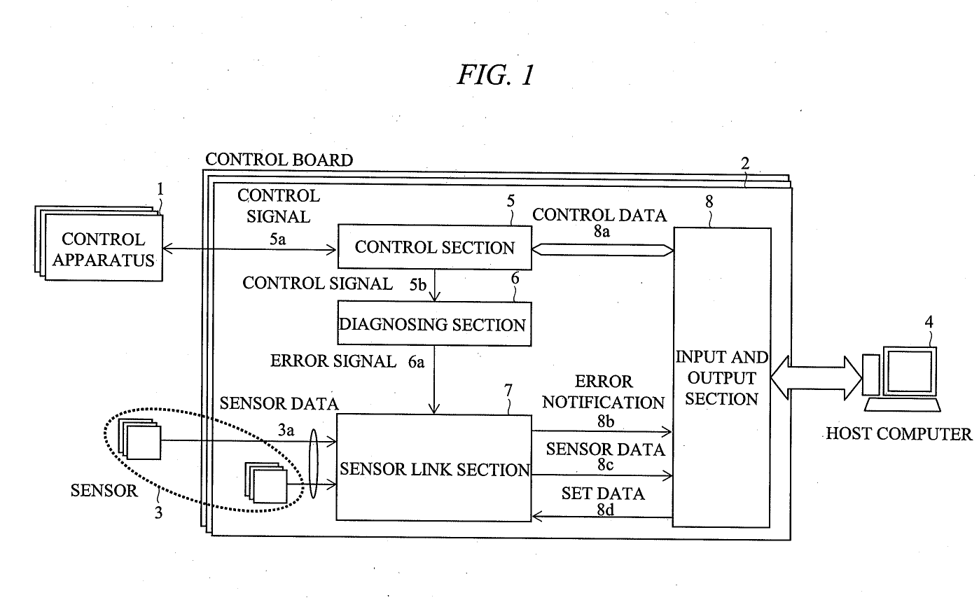

A system applying an apparatus diagnosing method which is a first embodiment of the present invention will be explained below with reference to FIGS. 1 to 7.

FIG. 1 is a diagram showing an entire configuration of a system according to the embodiment. The system includes: the control apparatuses 1 such as a motor, a pump, or an operation panel; the control boards 2 to control the control apparatus 1; the sensors 3 which are disposed around the control apparatuses 1 or the control boards 2, or mounted on the control boards 2 to measure data about the operation environments of the control apparatuses 1 and the control boards 2; and the host computer 4 serving as a control system which sets a control procedure, an operation mode, and the like to the control boards 2, and which collects error information of each control board 2 and the sensor data 3a from the sensors 3.

The control board 2 includes: the control section 5; the diagnosing section 6 which diagnoses an operation status of the control apparatus 1 or the control board 2 based upon a control signal 5b from the control section 5 to detect the error occurrence, and which outputs an error signal 6a; a sensor link section 7 which collects the error signal 6a and the sensor data 3a from the sensor 3 and associates (links) with each other; and an input/output section 8 which provides interface between the respective sections and the host computer 4.

A summary of an operation of the system according to the embodiment will be explained below.

In FIG. 1, first, control data 8a fed from the host computer 4 to the control board 2 is fed to the control section 5 via the input/output section 8. The control section 5 activates the control apparatus 1 connected to the control board 2 according to the control signal 5a generated based upon the control data 8a. At this time, the diagnosing section 6 performs various diagnoses based upon the control signal 5b from the control section 5. The sensor 3, which is disposed around the control apparatus 1 and the control board 2, or mounted on the control board 2, measures data about the operation environments of the control apparatus 1 and the control board 2, and inputs the acquired sensor data 3a into the sensor link section 7 of the control board 2.

Here, when an error state (abnormal operation) of the control apparatus 1 or the control board 2 is detected during apparatus operation by the diagnosing section 6, the diagnosing section 6 outputs the error signal 6a to input it into the sensor link section 7. The sensor link section 7 collects the sensor data 3a by storing the sensor data 3a in an internal memory with the error signal 6a as trigger. Control during the storing time is performed according to setting data 8d from the host computer 4. When collection of the sensor data 3a is terminated, the sensor link section 7 outputs error notification 8b, and notifies the host computer 4 of the error occurrence and the termination of collection of the sensor data 3a through the input/output section 8.

Incidentally, the diagnosing section 6 performs a logical error diagnosis based upon the control signal 5b from the control section 5, but it may conduct a diagnosis of wave quality of the control signal 5b and the sensor data 3a. For example, such a diagnosis is thought that degradation of an analog waveform of a control signal is diagnosed by sampling the waveform of the control signal with an A/D converter, measuring amplitude or a rising/falling time of the signal waveform, and comparing the measured value with an expected value.

Also, the sensor 3 comprises a sensor element, an amplifying section for amplifying an analog signal obtained from the sensor element, and an A/D converting section for converting the analog signal into a digital signal to output it, which are not shown. The sensor 3 measures data about the operation environments of the control apparatus 1 and the control board 2, such as temperature/humidity, acceleration (vibration), voltage/current, electromagnetic wave, or noise.

According to the system of the embodiment, for example, by using an acceleration sensor as the sensor 3, vibration data of the control apparatus 1 and the control board 2 and error information can be linked with each other, so that it is possible that, for example, contact failure of an apparatus wiring and a control board wiring due to vibrations is specified as an environmental factor which has caused the error. Also, By using a temperature/humidity sensor, temperature/humidity data around the control apparatus 1 and the control board 2 and error information can be linked with each other, so that it is possible that abnormal heat generation due to overloading, abnormal humidity due to wind and flood damage, or the like is specified as an environmental factor which has caused the error.

By using the electromagnetic field sensor, electromagnetic field intensity data around the control apparatus 1 and the control board 2 and error information can be linked with each other, so that it is possible that disturbance to the control apparatus 1 and the control board 2 or the like is specified as an environmental factor which has caused an error. Further, by using a combination of the above-mentioned sensors and a voltage/current sensor, an environmental factor which has caused an error, such as short-circuiting of a power source wiring due to vibrations, increase in noises of power source due to disturbance, or the like can be specified.

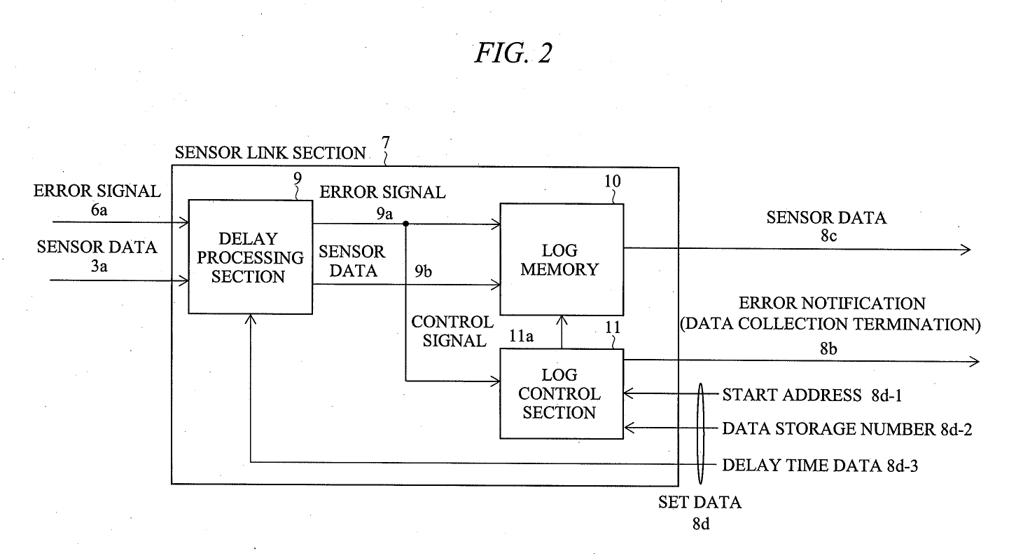

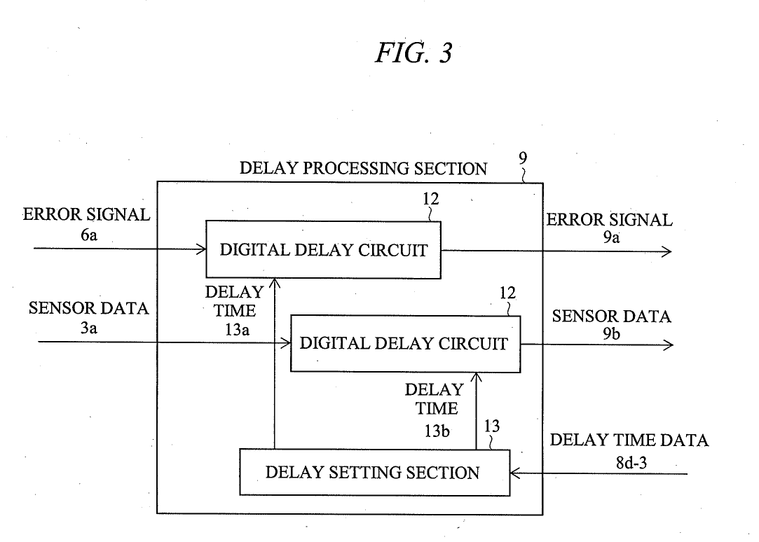

Next, a configuration and an operation of the sensor link section 7 will be explained with reference to FIGS. 2 and 3.

FIG. 2 is a diagram showing a configuration of the sensor link section 7 in the system according to the embodiment. The sensor link section 7 comprises: a delay processing section 9 which adjusts input-timings of the error signal 6a inputted from the diagnosing section 6 and the sensor data 3a inputted from the sensor 3; a log memory 10 storing an error signal 9a and sensor data 9b after timing-adjustment; and a log control section 11 which performs control for writing the error signal 9a and the sensor data 9b within a time period defined by the setting data 8d into the log memory 10 with the error signal 9a as trigger.

FIG. 3 is a diagram showing a configuration of the delay processing section 9 in the system according to the embodiment. The delay processing section 9 comprises a digital delay circuit 12 which delays respectively the error signal 6a and the sensor data 3a each to be inputted, and a delay setting section 13 which sets delay time data for each of them.

An operation of the sensor link section 7 will be explained below.

In FIG. 2, first, the error signal 6a and the sensor data 3a which have been inputted into the sensor link section 7 are inputted into the delay processing section 9. The delay processing section 9 adjusts timings for outputting the error signal 9a and the sensor data 9b to the log memory 10 according to predetermined delay time data 8d-3. For example, when there is a large difference in wiring delay time between the error signal 6a from the diagnosing section 6 and the sensor data 3a from the sensor 3 since the sensor 3 is disposed at a distant position from the control board 2, the delay processing section 9 can absorb the time difference between the error signal 6a and the sensor data 3a.

A start address 8d-1 and a data storage number 8d-2 indicating a storage range of the sensor data 9b at the error occurrence time can be set in the log control section 11. The log control section 11 performs writing control of the log memory 10 so as to store only the sensor date 9b which is within a defined time period by the start address 8d-1 and the data storage number 8d-2 with input of the error signal 9a as trigger. A control signal 11a outputted from the log control section 11 to the log memory 10 is a memory address signal or a writing control signal, although not shown. The memory address signal is generated by an address counter in the log control section 11.

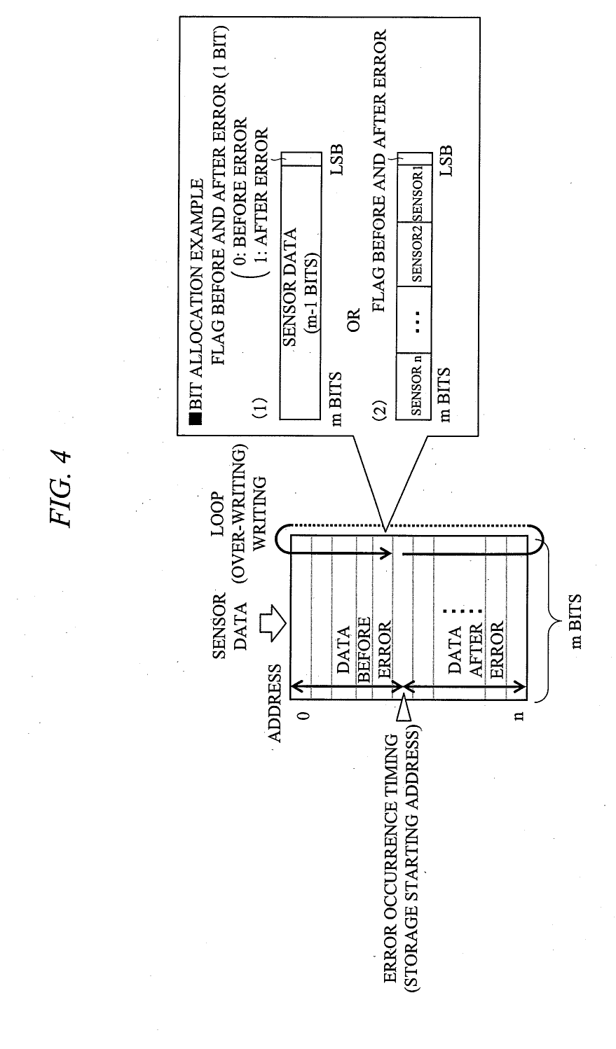

Next, a configuration and an operation of the log memory 10 will be explained with reference to FIGS. 4 to 6.

FIG. 4 is a diagram showing an operation of the log memory 10 and a bit allocation example of data when a memory with m bits×n words is used. At a normal time, the log memory 10 performs a loop storing operation in which the memory 10 sequentially writes data with m bits from a leading address (0 address) up to a final address (n address), and when the final address (n address) is filled in, it returns back to the leading address to continue writing data with overwriting.

For bit allocation of data to be written, as shown in a bit allocation example (1) in FIG. 4, one bit flag for determining whether the sensor data 9b is before the error or after the error is provided in the least significant bit (LSB), and the sensor data 9b is stored in an upper bit. As shown in a bit allocation example (2), the sensor data 9b from the plurality of the sensors 3 may be allocated and stored in the upper bit.

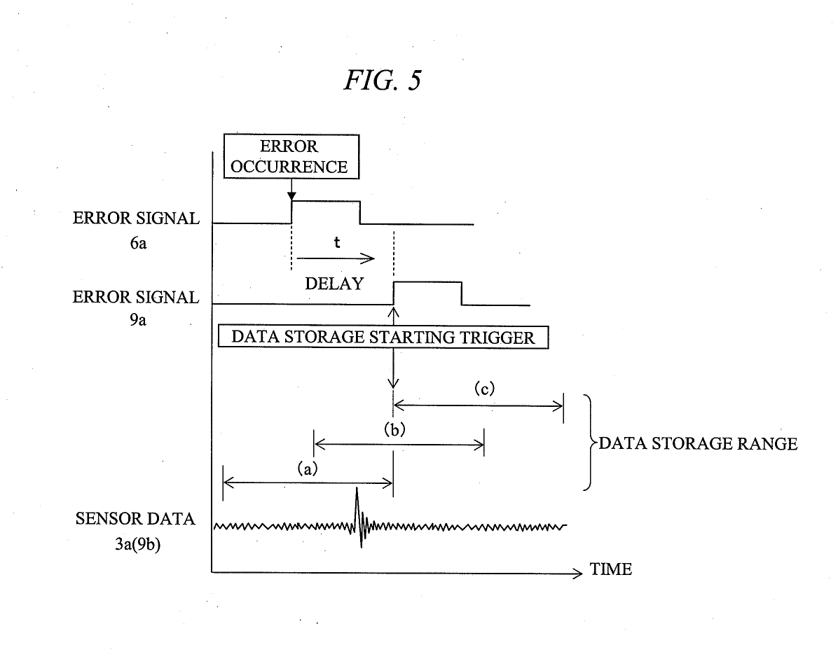

FIG. 5 is a diagram showing an example of timing adjustment in the sensor link section 7 and a storage range of the sensor data 3a corresponding to the error signal 9a in the system according to the embodiment. In FIG. 5, the error signal 6a from the diagnosing section 6, the timing-adjusted error signal 9a, and the sensor data 3a are shown on the same time axis. The example shown in FIG. 5 shows the case where the sensor data 3a from the sensor 3 is inputted into the sensor link section 7 later than the error signal 6a from the diagnosing section 6. A time difference between the error signal 6a and the sensor data 3a is absorbed so as to match timing thereof by delaying the error signal 6a by time t with a digital delay circuit 12 in the delay processing section 9. The time t to be delayed is preliminarily set in a delay setting section 13 in the delay processing section 9 by the delay time data 8d-3.

The storage range of the timing-adjusted sensor data 9b is determined by a rising of the timing-adjusted error signal 9a. Storage of the sensor data 9b is started with the rising of the error signal 9a as trigger. The storage range of the sensor data 9b can be selected from (a) a range only before the error occurrence, (b) a range before and after the error occurrence, and (c) a range only after the error occurrence according to the start address 8d-1 and the data storage number 8d-2 which are setting values in the log control section 11.

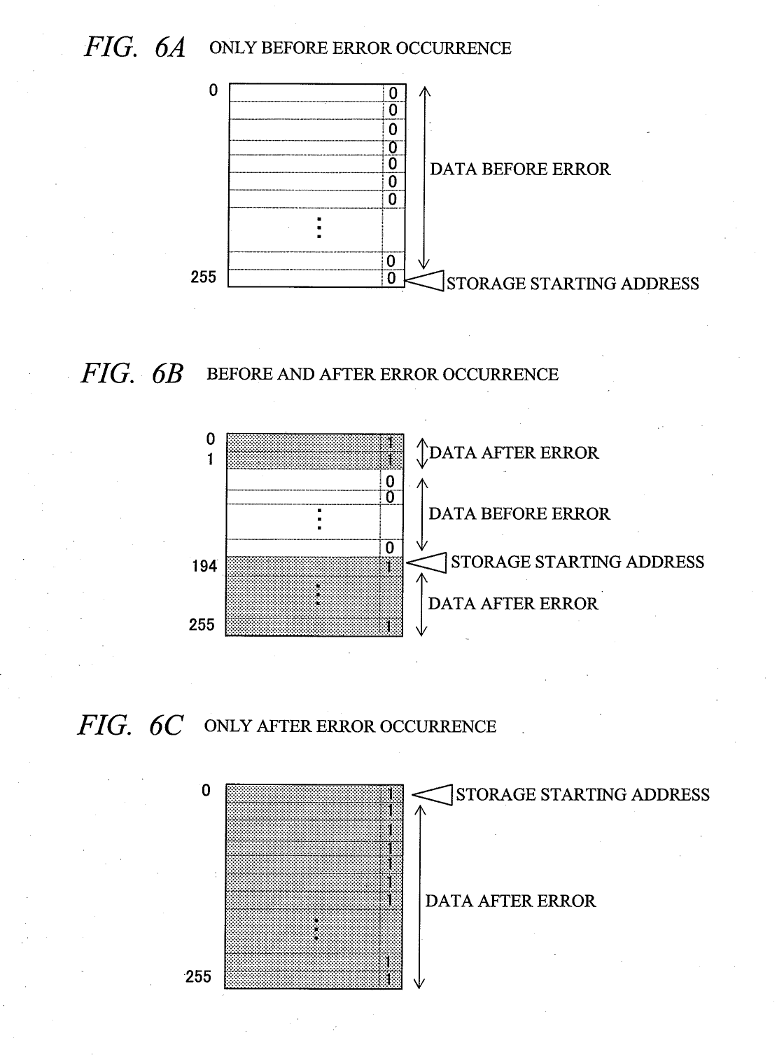

FIGS. 6A to 6C are diagrams showing a storage example of the sensor data 9b into the log memory 10 when the log memory 10 with 256 words is used. FIG. 6A shows a state of the log memory 10 in the case where the log memory 10 is set so as to store only the sensor data 9b before the error occurrence. The minimal value “0” is set in the data storage number 8d-2 of the log control section 11. In this case, writing of the sensor data 9b into the log memory 10 at a normal time is just stopped when the error signal 9a is inputted into the log control section 11. Thereafter, since the sensor data 9b is not newly written, data which has been already stored in the log memory 10 can be collected as the sensor data 9b before the error occurrence.

FIG. 6B shows a state of the log memory 10 when the log memory 10 is set so as to store the sensor data 9b before and after the error occurrence. The data number of the sensor data 9b after the error occurrence to be collected is set in the data storage number 8d-2 of the log control section 11. FIG. 6B is an example where “64” which is ¼ of a memory size is set. In this case, a current address counter value is not cleared and 64 pieces of the sensor data 9b are newly stored in the log memory 10 following the sensor data 9b at a normal time (before the error occurrence) which has been stored until present time in the log control section 11. When data writing reaches the final address during storing the data after the error occurrence, storing the sensor data 9b is continued when the data writing returns back to the leading address like the loop storage operation at a normal time. The sensor data 9b before and after the error occurrence can be collected by the above-mentioned control.

FIG. 6C shows a state of the log memory 10 when the log memory 10 is set so as to store only the sensor data 9b after the error occurrence. In this case, by setting “0” in the start address 8d-1 of the log control section 11 (a current address counter value is cleared) and setting the data storage number 8d-2 to “1256” (the maximum word number of the log memory 10), the sensor data 9b is overwritten from the leading address to the final address of the log memory 10 after the error occurrence so that only the sensor data 9b after the error occurrence can be collected.

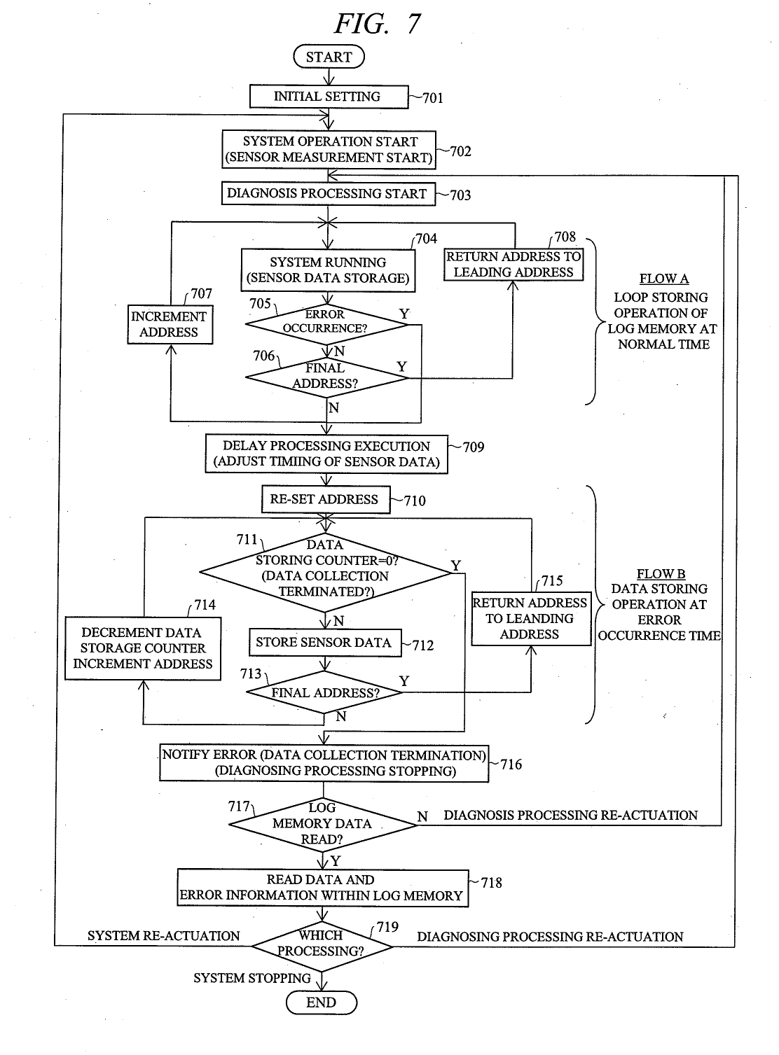

FIG. 7 is a flowchart representing a flow of an apparatus diagnosing processing in the system according to the present embodiment.

First, in the step 701, initial settings of the start address 8d-1 and the storage number 8d-2 for determining a data storage range at the error occurrence time, the delay time data 8d-3 between the error signal 6a and the sensor data 3a, and the like shown in FIG. 2 are conducted. Next, in the step 702, an operation of the system is started and measurement of data about the operation environment by the sensor 3 is started. Next, in the step 703, a diagnosing processing in the diagnosing section 6 is started.

Thereafter, a flow A in FIG. 7 which is a loop storing operation to the log memory 10 at a normal time is performed in the sensor link section 7. First, the sensor data 3a measured by the sensor 3 is stored in the log memory 10, and the storage is sequentially continued from the leading address during the normal operation while incrementing the address counter in the log control section 11 (step 704→step 705→step 706→step 707). When the storage is filled up to the final address, the address counter is returned back to the leading address (step 704→step 705→step 706→step 708) and the storage of the sensor data 3a is continued from the leading address with overwriting again (step 704→step 705→step 706→step 707).

Here, when an error is detected in the diagnosing section 6 during processing of the flow A and the error signal 6a is inputted into the sensor link section 7, the error occurrence is determined in the step 705 and the operation comes out of the loop of the flow A and proceeds to a processing of the step 709. In the step 709, after stopping the diagnosing processing in the diagnosing section 6, the timing adjustment between the error signal 6a and the sensor data 3a is performed in the delay processing section 9 of the sensor link section 7, and the error signal 9a serving as a storage starting trigger for storing the sensor data 9b is outputted.

Input of the error signal 9a into the log control section 11 is as trigger, and thereafter, a flow B shown in FIG. 7 which is a data storing operation at the error occurrence time is performed. First, the address counter in the log control section 11 is set again to determine a storage starting address of the sensor data 9b after the error occurrence (step 710). Next, an initial value of the data storage counter is set to the data number of the sensor data 9b to be collected after the error occurrence, which is defined by the data storage number 8d-2, and storing the sensor data 9b into the log memory 10 is repeated while decrementing the data storage counter until the data storage counter reaches “0” (step 711→step 712→step 713→step 714).

When the address counter proceeds to the final address before the data storage counter reaches “0”, the address counter is cleared and data storing from the leading address is repeated like the above-mentioned loop storing operation at a normal time (step 711→step 712→step 713→step 715). When the data storage counter becomes “0” in the step 711, the data storing operation at the error occurrence time is terminated, and the control comes out of the flow B and proceeds to a processing in the step 716.

After error (data collection termination) notification 8b to the host computer 4 is performed in the step 716, a subsequent processing is performed according to an instruction from the host computer 4. When data reading from the log memory 10 is not performed, the diagnosing processing is re-actuated directly (step 717→step 703). When data reading is performed, after the sensor data 9b and the error information in the log memory 10 are read and transmitted to the host computer 4 in the step 718, re-actuation of system (step 719→step 702), re-actuation of the diagnosing processing (step 719→step 703), or termination of the apparatus diagnosing processing due to the system stopping is performed according to an instruction from the host computer 4.

Incidentally, the system according to the embodiment has a configure in which the sensor data 9b and the error information read by data reading-out in the step 718 are transmitted to the host computer 4 which is a control system via a communication line or the like, but it is not limited to this configuration. It may be possible to make a configuration in which a control system is not provided therewith, so that stored data in the log memory 10 is directly collected with another storage medium by a worker in charge or the like on the spot, or the log memory 10 is mounted as a portable storage medium and the storage medium is collected by a worker in charge or the like on the spot. Accordingly, the apparatus diagnosing method of the present invention is applicable to even a configuration without a host computer or the like which is the control system, such as home electronics or an automobile.

As explained above, in the system according to the present embodiment, each control board 2 in the system includes the diagnosing section 6 and the sensor link section 7, and the sensor data 3a and the error signal 6a are associated (linked) with each other with the error signal 6a as trigger when an error occurs. Also since only the sensor data 9b before and after the error occurrence can be stored in the log memory 10 on the control board 2, when the error has occurred due to change in the operation environment, only sensor information before and after the error occurrence can be collected by reading contents linked to the error in the log memory 10. Further, an environmental factor which has caused the error can be specified by analyzing the sensor information.

### Second Embodiment

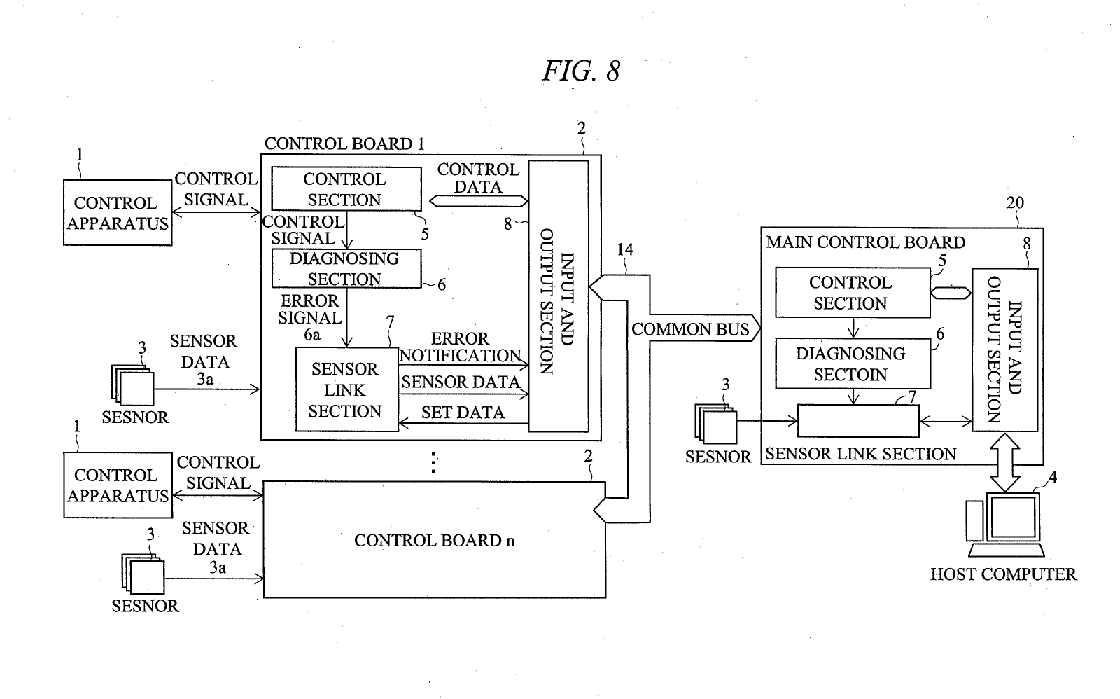

A system applying an apparatus diagnosing method according to a second embodiment of the present invention will be explained below with reference to FIG. 8.

FIG. 8 is a diagram showing an entire configuration of the system according to the present embodiment. In the system according to the present embodiment, such a configuration is made that the plurality of control boards (1 to n) 2, each of which controls each of the plurality of control apparatuses 1, are connected to the main control board 20 via a common bus 14 and the main control board 20 performs the overall control of each control apparatus 2. Here, internal configurations of each control board 2 and the main control board 20 have the same configurations as shown in FIG. 1 and explained in the first embodiment. Each of control boards 2 and the main control board 20 each include the control section 5, the diagnosing section 6, the sensor link section 7, and an input/output section 8, and the sensor data 3a linked to the error signal 6a can be collected on each control board.

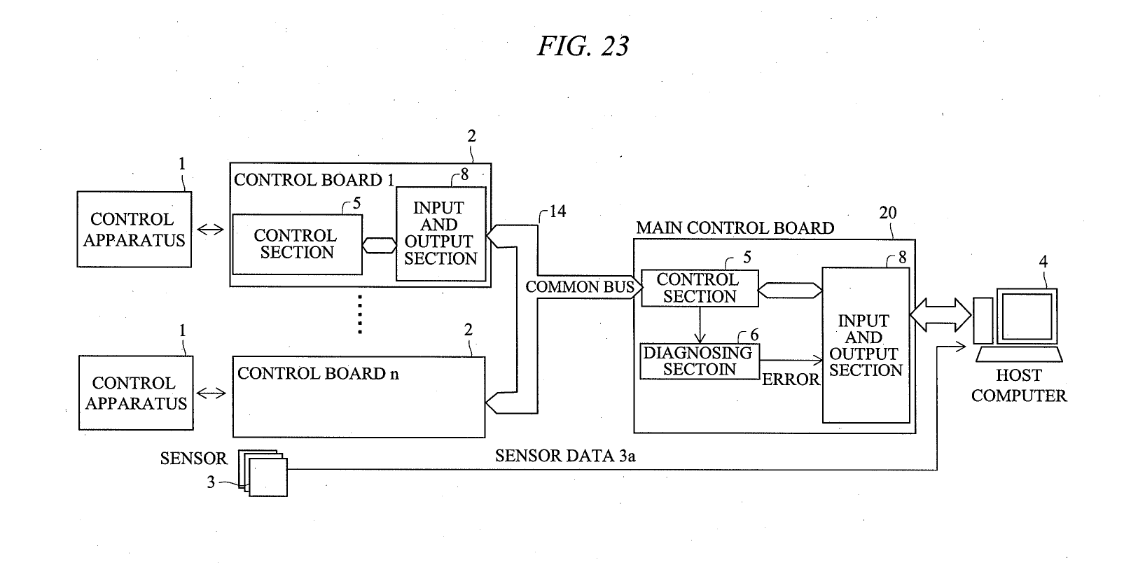

Conventionally, in the case of a configuration in which the main control board 20 controls each control board 2 as the configuration shown in FIG. 23, since an error at each control board 2 is detected by the diagnosing section 6 in the main control board 20, it is difficult that the error occurrence time on each control board 2 and the sensor data 3a correspond each other. However, according to the system of the present embodiment, since the sensor data 3a which can be linked to the error signal 6a can be collected on each control board 2, a target control board 2 and an environmental factor which has caused the error can be specified when the error occurs.

### Third Embodiment

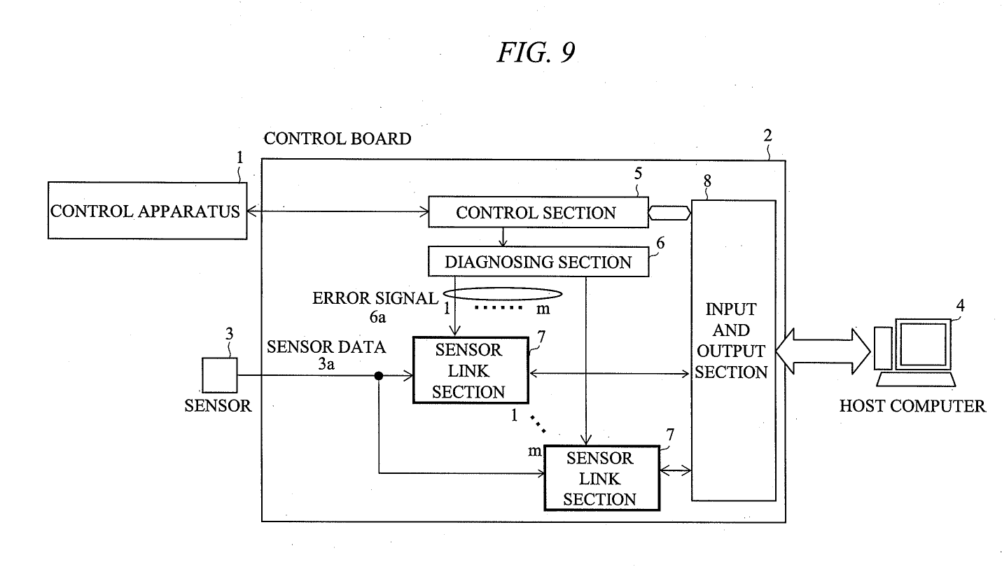

A system applying an apparatus diagnosing method according to a third embodiment of the present invention will be explained below with reference to FIGS. 9 to 18. The system according to the present embodiment is a system that includes the configuration shown in FIG. 1 and explained in the first embodiment as a basic configuration, and has various configurations of the diagnosing section 6 and the sensor link section 7.

FIG. 9 shows a configuration in which the same sensor data 3 is linked to each of the plurality of error signals 6a and is collected. As shown in the entire configuration of the system in FIG. 9, the control board 2 includes the diagnosing section 6 which outputs plural kinds of the error signals (1 to m) 6a and the same number of the sensor link sections (1 to m) 7 as the number of the error signals 6a, and it is characterized by inputting the same sensor data 3a into the respective sensor link sections 7. According to the configuration, the sensor data 3a can be linked to each kind of generated errors and be collected.

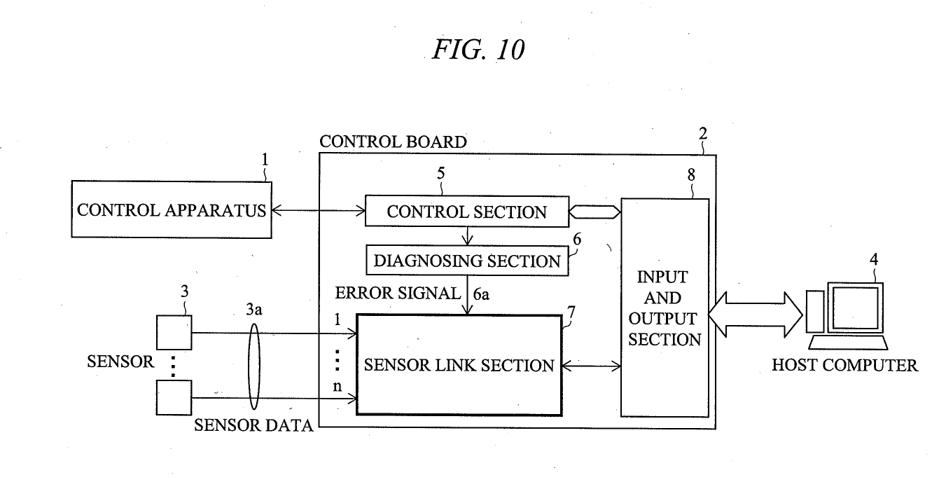

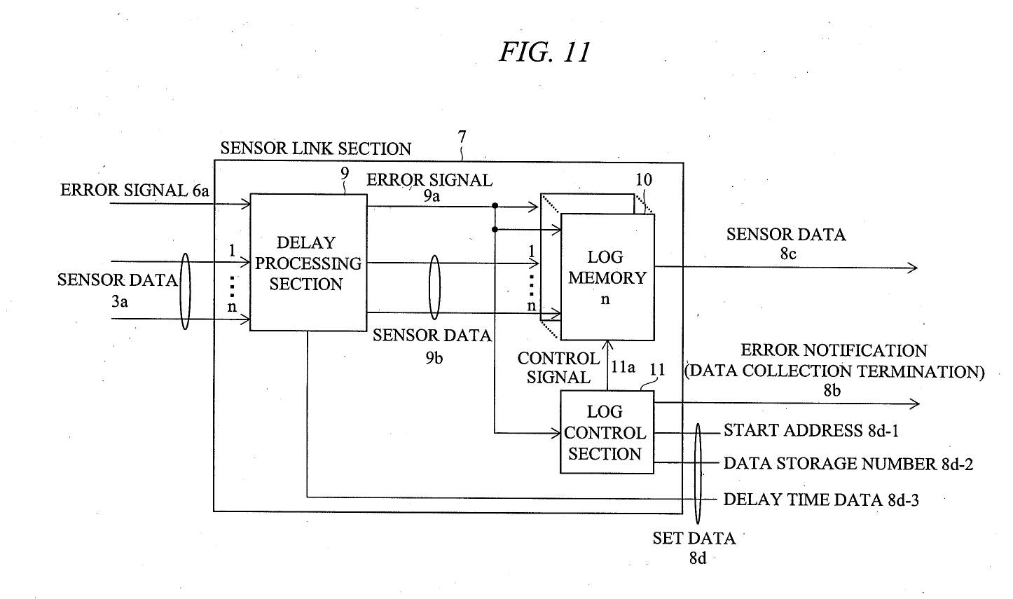

FIGS. 10 to 11 show a configuration in which the plurality of pieces of sensor data 3a is linked to the same error signal 6a and is collected. As shown in the entire configuration in FIG. 10, the plurality of pieces of sensor data (1 to n) 3a are inputted to the sensor link section 7.

FIG. 11 is a diagram showing a configuration of the sensor link section 7 of FIG. 10. The sensor link section 7 is characterized by having the same number of the log memories 10 as the number of the sensor data 3a (1 to n) to be inputted, and having the plurality of log memories 10 storing the respective sensor data 3a. According to the configuration, the plurality of pieces of sensor data 3a can be linked to one kind of the error signal 6a from the diagnosing section 6, and be collected.

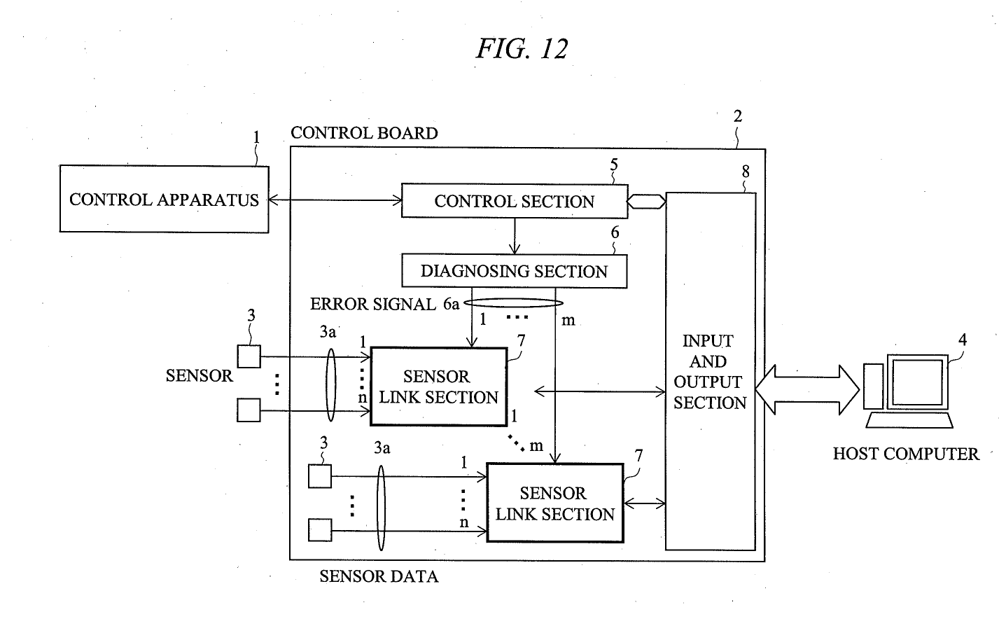

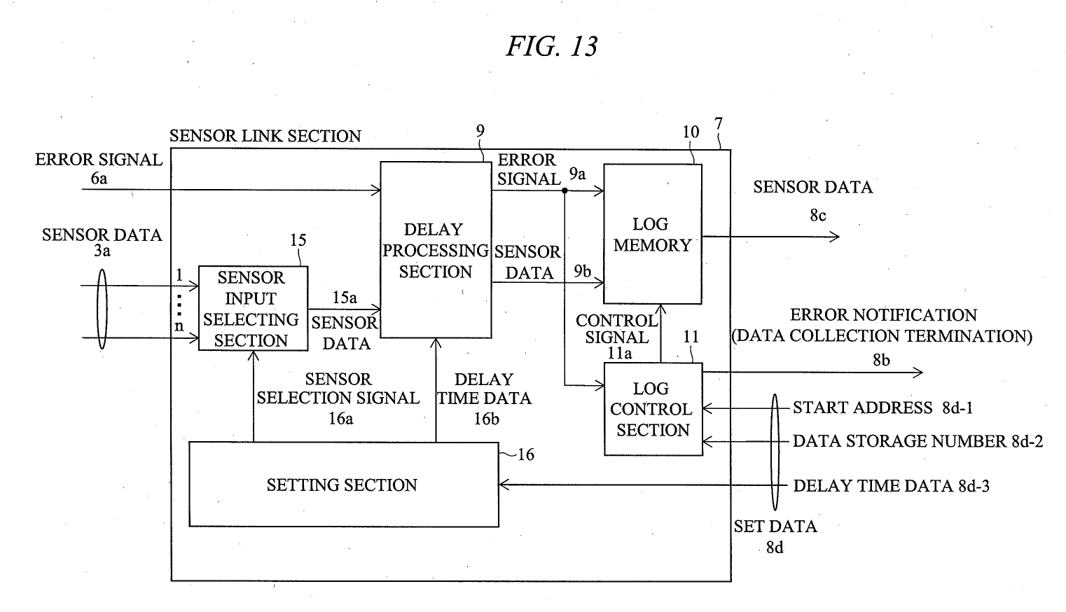

FIGS. 12 and 13 show a configuration in which the sensor data 3a selected by a user is respectively linked to the plurality of error signals 6a, and is collected. As shown in the entire configuration of the system of FIG. 12, the control board 2 includes the diagnosing section 6 which outputs plural kinds of the error signals (1 to m) 6a and the same number of the sensor link sections (1 to m) 7 as the number of the error signals 6a.

FIG. 13 is a diagram showing a configuration of the sensor link section 7 in FIG. 12. The sensor link section 7 is characterized by including, in addition to the configuration of the above-mentioned sensor link section 7 shown in FIG. 2, a sensor input selecting section 15 which selects one data from the plurality of pieces of inputted sensor data 3a and outputs the one, and a setting section 16 which outputs a sensor selection signal 16a and delay time data 16b based upon the setting data 8d from the host computer 4. The sensor input selecting section 15 comprises a selector (not shown) which selects one data from the plurality of pieces of inputted sensor data 3a and outputs the one data as sensor data 15a based upon the sensor selection signal 16a from the setting section 16.

According to the configuration, the plural pieces of sensor data 3a to be collected can be selected from the plurality of pieces of sensor data 3a outputted from the plurality of sensors 3 which are disposed on the control apparatus 1 and the control board 2. Further, the plural pieces of sensor data 3a can be linked to each kind of the generated errors and be collected.

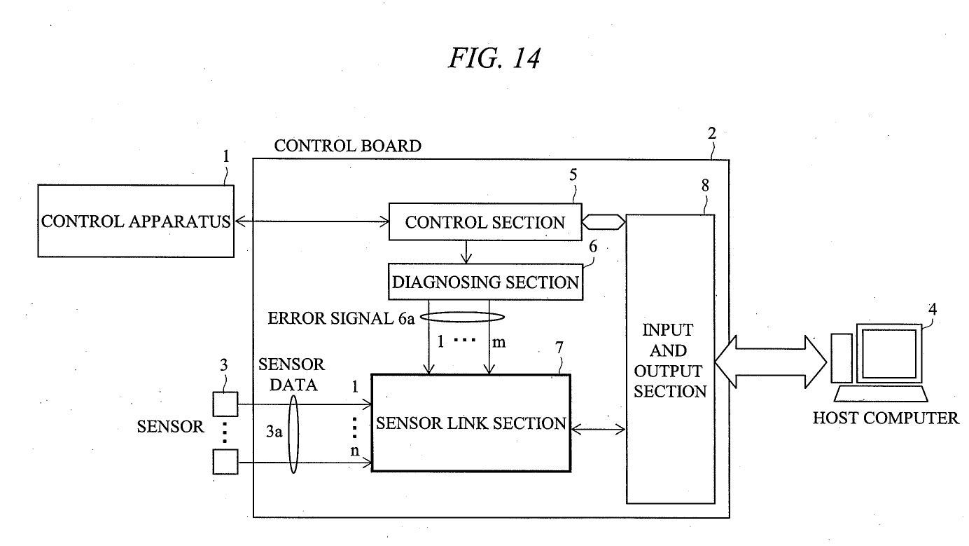

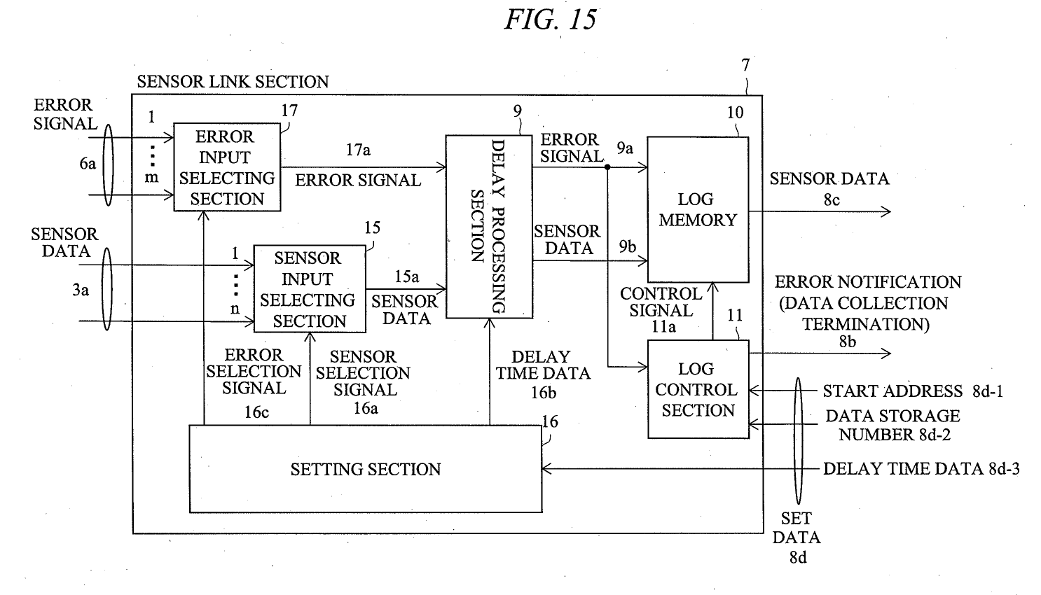

FIGS. 14 and 15 show a configuration in which the sensor data 3a selected by a user is linked to the error signal 6a selected by a user and is collected. As shown in the entire configuration of the system in FIG. 14, the control board 2 includes the diagnosing section 6 which outputs plural kinds of the error signals (1 to m) 6a and the sensor link section 7 which is inputted with the error signals (1 to m) 6a and the plurality of pieces of sensor data (1 to n) 3a.

FIG. 15 is a diagram showing a configuration of the sensor link section 7 of FIG. 14. The sensor link section 7 is characterized by including, in addition to the configuration of the above-mentioned sensor link section 7 shown in FIG. 13, an error input selecting section 17 which selects one signal from the plural inputted error signals (1 to m) 6a and outputs the one signal.

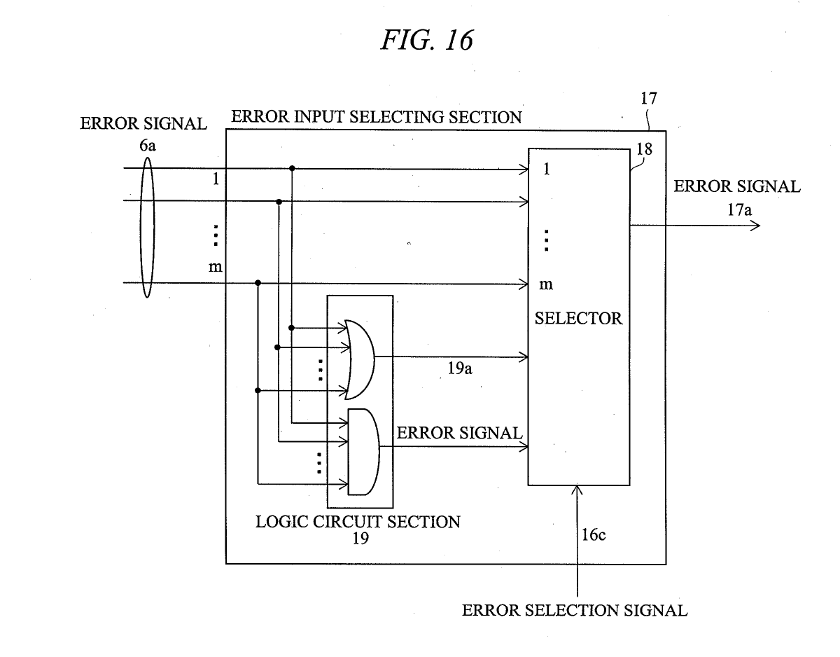

FIG. 16 is a diagram showing a configuration of the error input selecting section 17 of FIG. 15. The error input selecting section 17 is configured by a selector 18 and a logic circuit section 19. The selector 18 is inputted with the respective error signals 6a and with an error signal 19a generated in a logic circuit section 19 based upon the respective error signals 6a, and outputs one error signal 17a selected from these error signals based upon an error selection signal 16c inputted from the setting section 16 in the sensor link section 7. Whereby, it is possible to select which kinds of errors are to be linked to the sensor data 3a.

Incidentally, as shown in FIG. 16, the logic circuit section 19 according to the configuration has only outputs of an OR and AND of all the error signals 6a, but the plurality of error signals 19a may be produced by another combination circuit.

According to the present configuration, the plural pieces of sensor data 3a to be collected can be selected from the plurality of pieces of sensor data 3a outputted from the plurality of sensors 3 disposed on the control apparatus 1 and the control board 2, and a kind of generated errors can be selected. Therefore, the selected sensor data 3a, which is linked to the selected kind of errors by a user, can be collected.

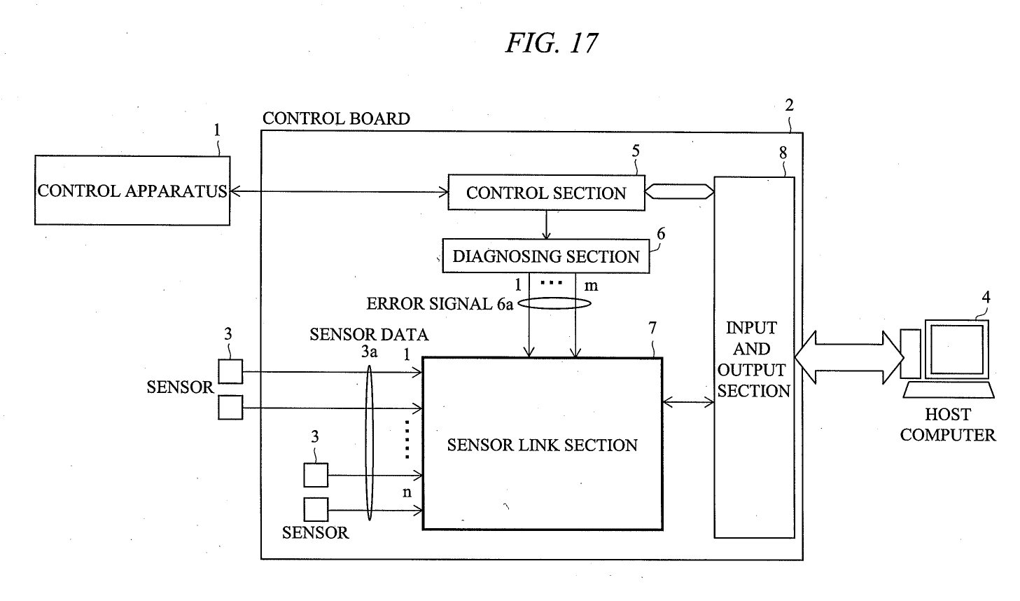

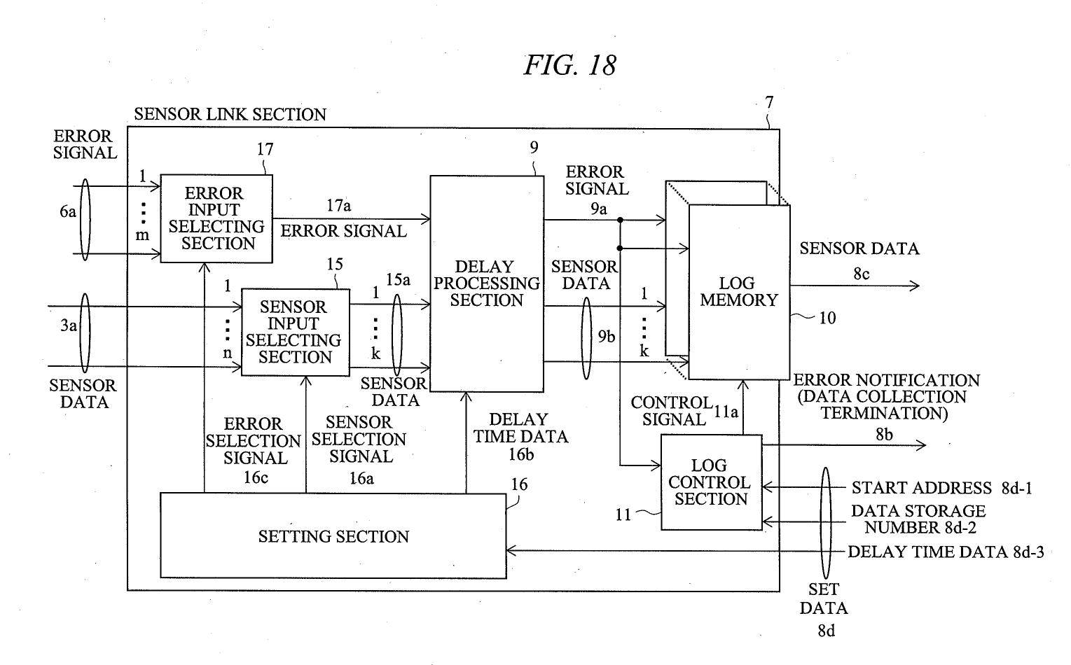

FIGS. 17 and 18 show a configuration in which the plurality of pieces of sensor data 3a selected by a user are linked the error signals 6a selected by the user, and are collected. As shown in the entire configuration of the system of FIG. 17, the control board 2 includes the diagnosing section 6 which outputs plural kinds of the error signals (1 to m) 6a and the sensor link section 7 which is inputted with the error signals (1 to m) 6a and the plurality of pieces of sensor data (1 to n) 3a.

FIG. 18 is a diagram showing a configuration of the sensor link section 7 of FIG. 17. The sensor link section 7 has a configuration in which a sensor input selecting section 15 selects the plurality of sensor data (1 to k) 15a from the plural inputted sensor data (1 to n) 3a, and outputs the sensor data (1 to k) 15a in the configuration of the above-mentioned sensor link section 7 shown in FIG. 15. It is characterized by having the same number of the plurality of log memories (1 to k) 10 as the number of the sensor data 3a which is selectable in the sensor input selecting section 15.

According to the configuration, since the plurality of log memories 10 are provided and the plurality of pieces of sensor data 3a can be selected, the plural pieces of sensor data 3a to be collected can be selected from the plurality of pieces of sensor data 3a from the plurality of sensors 3 disposed on the control apparatus 1 and the control board 2. Further, the selected plural pieces of sensor data 3a can be linked to each kind of errors selected arbitrarily by a user, and be collected.

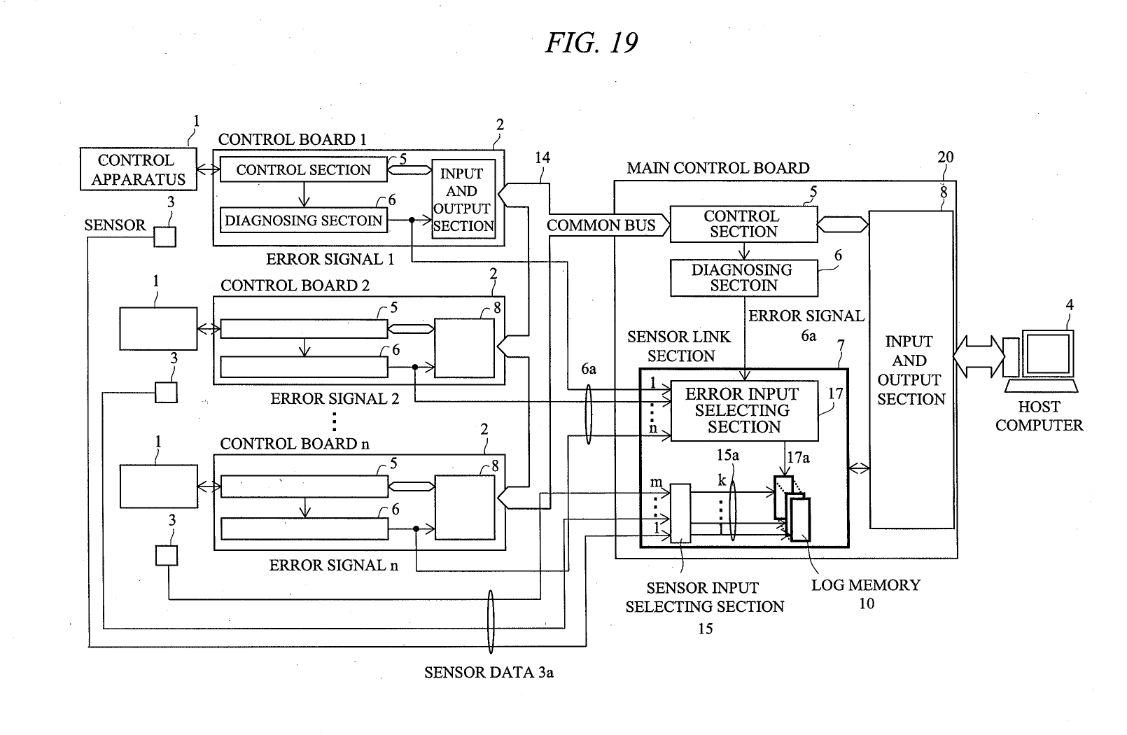

FIG. 19 is a diagram showing an example of a configuration of the diagnosing section 6 and the sensor link section 7, wherein the plurality of control boards (1 to n) 2 are connected to the main control board 20 via the common bus 14 and the main control board 20 performs the overall control of the respective control boards 2.

The main control board 20 is provided with the above-mentioned sensor link section 7 shown in FIG. 18. The sensor link section 7 is inputted with the error signals 6a drawn out from the respective control boards 2 through other wirings instead of the common bus 14 and are also inputted with the plurality of pieces of sensor data 3a from the sensors 3 disposed on the control apparatus 1 and the respective control boards 2 through other wirings. The sensor link section 7 selects the error signal 17a, which is used for linkage with the sensor data 3a, from the inputted error signals 6a by an error input selecting section 17, and stores the plurality of pieces of sensor data (1 to k) 15a which are selected from the plurality of pieces of sensor data 3a and linked to the error signal 17a into the corresponding log memories (1 to k) 10.

According to the configuration, even if the sensor link sections 7 are not provided on all of the control boards 2, the sensor data 3a can be linked to each kind of errors arbitrarily selected by a user, and be collected.

As configuration examples described above, since the sensor data 3a linked to the error signals 6a can be collected in various configurations of a combination of the number of the error signals 6a, the number/positions of the sensors 3, the number of the log memories 10, the number of the control boards 2, and the like, the apparatus diagnosing method of the present invention can be adopted to hardware configurations of various apparatuses and be incorporated in the various apparatuses. Besides the above-mentioned configuration examples, another configuration depending on a combination of the number of the error signals 6a, the number/positions of the sensors 3, the number of the log memories 10, the number of the control boards 2, and the like can be proposed, but the feature of the present invention lies in that the sensor data 3a is linked to the error signal 6a on the control board 2 and is collected, and a configuration of the system is not limited to the above-mentioned configurations.

### Fourth Embodiment

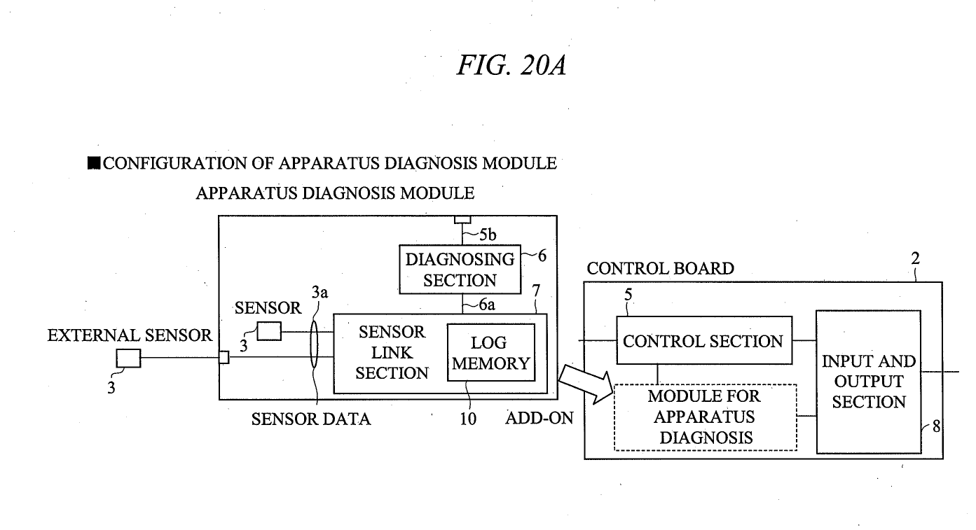

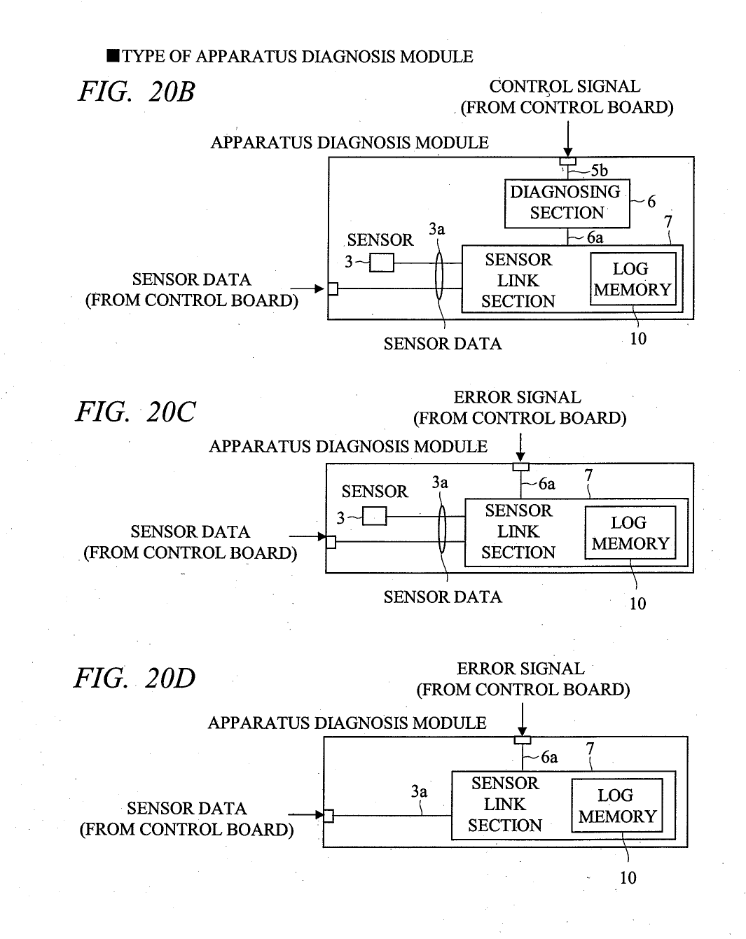

An apparatus diagnosis module according to a fourth embodiment of the present invention will be explained below with reference to FIGS. 20A to 20D.

FIG. 20A is a rough diagram showing an apparatus diagnosis module including respective sections for linking between the sensor data 3a and the error signal 6a. The module for apparatus diagnosis includes the diagnosing section 6, the sensor link section 7, and the sensor 3, which are in the same configuration as the configuration shown in FIG. 2. The module for apparatus diagnosis can be mounted to the existing control board 2 as an add-on type module.

FIGS. 20B to 20D are diagrams showing various examples of a configuration of the diagnosing section 6 and the sensor 3 in an apparatus diagnosis module according to the embodiment. FIG. 20B shows a configuration in which the diagnosing section 6 is provided and a control signal is inputted from the control board 2 into the diagnosing section 6. FIGS. 20C and 20D show configurations in which without the diagnosing section 6, the error signal outputted according to the diagnosing processing on the control board 2 is directly inputted into the sensor link section 7. FIGS. 20B and 20C show a configuration in which the sensor 3 is provided on the module for apparatus diagnosis. FIG. 20D shows a configuration in which the sensor data 3a is inputted from the sensor 3 on the control apparatus 1 or the control board 2.

By adopting such a configuration, the apparatus diagnosis module of the present invention can be flexibly mounted on control boards of various apparatuses. The apparatus diagnosis module can be mounted by incorporating during manufacturing of a control board of an apparatus, and further the apparatus diagnosis module can be additionally mounted on a control board of an existing apparatus in operation by making the module to be an add-on type.

### Fifth Embodiment

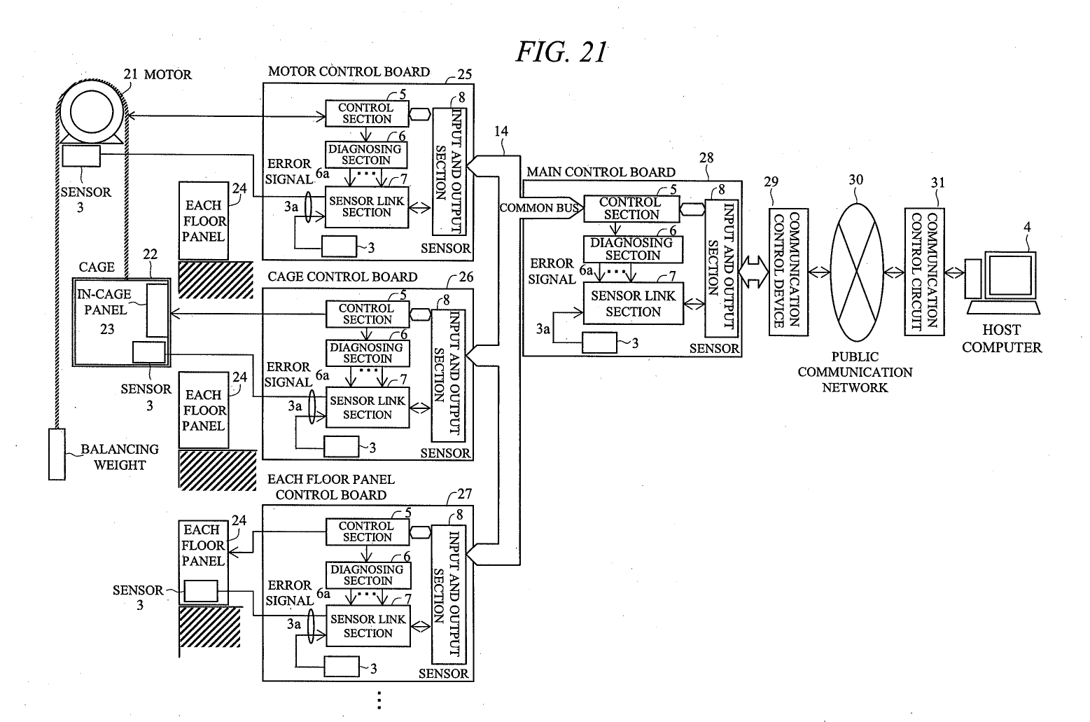

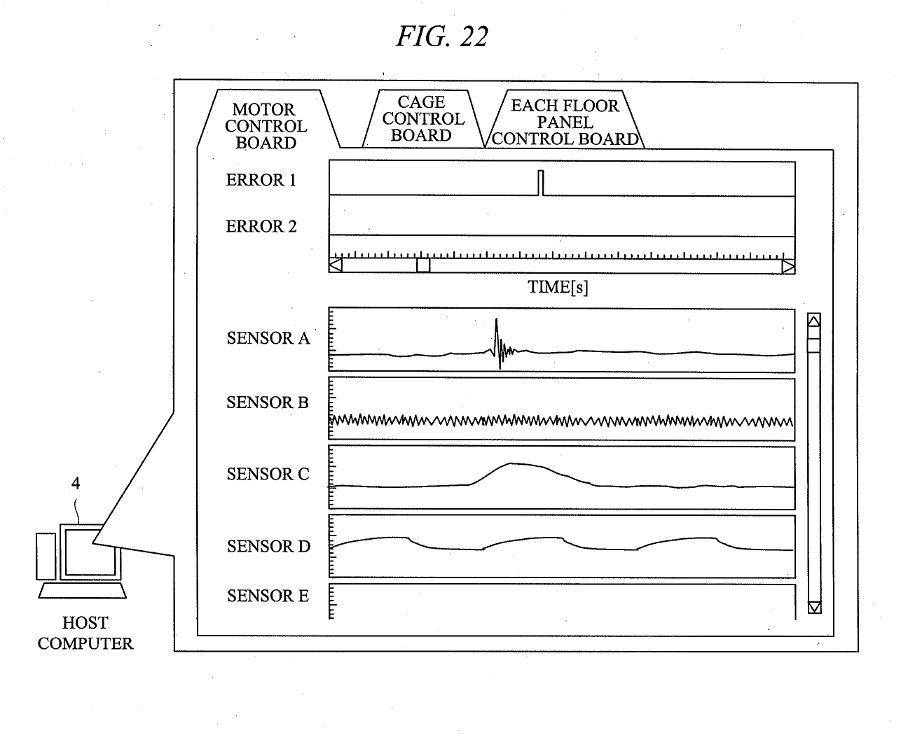

A system applying an apparatus diagnosing method according to a fifth embodiment of the present invention will be explained below with reference to FIGS. 21 and 22.

FIG. 21 is a diagram showing an example where the apparatus diagnosing method of the present invention has been applied to a remote monitoring-diagnosing system of an elevator. An elevator comprises a cage 22 for passengers, a motor 21 for moving the cage, an in-cage panel 23 for controlling a destination of the cage, respective floor panels 24 for controlling calling of the cage at each floor, and the like, which are control apparatuses. An exclusive control board (a motor control board 25, a cage control board 26, an each-floor panel control board 27) is connected to each control apparatus. The respective control boards 25 to 27 are connected to a main control board 28 via a common bus 14, and the main control board 28 performs the overall control of the respective control boards 25 to 27. The main control board 28 is connected to a public communication network 30 via a communication control apparatus 29, and the main control board 28 is monitored and controlled by the host computer 4, which is also connected to the public communication network, in such as a monitoring center.

The sensors 3 for measuring data about the operation environments are provided on the respective control apparatuses 21 to 24, and the sensors 3 measuring data about the operation environments of boards are provided on the respective control boards 25 to 28 including the main control board 28.

The respective control boards 25 to 28 in the remote monitoring-diagnosing system according to the embodiment include the control section 5, the diagnosing section 6 which outputs plural kinds of signals (1 to m) 6a based upon internal data from the control section 5, and the sensor link section 7. When the error occurs, the sensor data 3a, which is obtained by measuring data about the operation environments near respective control apparatuses and on the respective control boards, can be linked to the error signals 6a outputted from the diagnosing section 6, and be collected. The collected sensor data 3a is transmitted to the host computer 4 through the public communication network 30 by the main control board 28.

FIG. 22 is a diagram showing a display example of the collected sensor data 3a at the error occurrence time on the host computer 4. In the remote monitoring-diagnosing system according to the embodiment, a display screen for a result is prepared for each control board, so that information about the error and a status of the sensor data for each control board can be confirmed by switching the display screens by a tab. In FIG. 22, information of error 1 and error 2 which are kinds of the error signals 6a of the motor control board 25, and the sensor data A to E which are kinds of the sensor data 3a collected with linking to error 1 has been displayed.

Thus, in the remote monitoring-diagnosing system according to the embodiment, since the sensor data 3a only for the time periods before and after the error occurrence is linked to the error signal 6a and is collected by hardware, only the sensor data for the time periods before and after the error occurrence can be collected and confirmed in the host computer 4 without performing such a software processing as extraction from a vast amount of the regularly measured sensor data, so that the environmental factor which has caused the error can be specified.

The invention made by the inventors has been concretely explained above based upon the embodiments. However, it is needless to say that the present invention is not limited to the above-mentioned embodiments and can be modified variously without departing from the gist of the invention.

The apparatus diagnosing method and the apparatus diagnosis module of the present invention can be utilized in an apparatus and a system whose failure detection is required, such as an apparatus like an elevating machine, an automobile, an electric train, a robot, a medical device, a semiconductor inspecting apparatus, a plant such as a factory and an electric power plant, and the like. The apparatus diagnosing method and the apparatus diagnosis module of the present invention can also be utilized as a self-diagnostic function for a home electric appliance and the like, and an internal diagnostic function for a semiconductor device such as a microcomputer or a CPU.

What is claimed is:

1. An apparatus diagnosing method in an apparatus including a control apparatus and control boards for controlling the control apparatus, wherein on each of the control boards, an error occurrence at the control apparatus and the control board is detected, an error signal is outputted, sensor data outputted from a sensor acquiring data about operation environments of the control apparatus and the control boards are collected, and an environmental factor causing a failure or an error of the control apparatus and the control boards is specified based upon the error signal and the sensor data,
the method comprising the step of collecting the sensor data in association with the error signal when the sensor data is collected.

2. The apparatus diagnosing method according to claim 1,
wherein when the sensor data is collected in association with the error signal, the sensor data is associated with the error signal by adjusting a timing between the error signal and the sensor data.

3. The apparatus diagnosing method according to claim 1,
wherein when the sensor data is collected in association with the error signal, if there are the error signal or a plurality of error signals and the sensor data or a plurality of pieces of sensor data, the error signal or plurality of error signals and the sensor data or plurality of pieces of sensor data are inputted, and the sensor data is associated with the error signal by a combination of a kind of the error signal and a kind of the sensor data.

4. The apparatus diagnosing method according to claim 1,
wherein when the sensor data is collected in association with the error signal, only the sensor data before and after the error occurrence is collected based upon the error signal.

5. The apparatus diagnosing method according to claim 4,
wherein when the sensor data is collected in association with the error signal, the sensor data is collected in a storage medium which is located on the control board and into which the sensor data is inputted.

6. The apparatus diagnosing method according to claim 1,
wherein the apparatus including the control apparatus or a plurality of control apparatuses and the control board or a plurality of control boards further comprises a control system for controlling the respective control boards, and
the sensor data collected by the respective control boards is further collected by the control system.

7. An apparatus diagnosis module in an apparatus including a control apparatus and a control board for controlling the control apparatus, the module comprising:
a sensor link section collecting sensor data in association with an error signal when the error signal outputted from the control board due to detection of an error occurrence at the control apparatus and the control board, and the sensor data outputted from a sensor acquiring data about operation environments of the control apparatus and the control board are inputted thereto,
wherein the sensor link section comprises: a delay processing section outputting the sensor data in association with the error signal by adjusting a timing between the error signal and the sensor data; one or plural log memories storing the sensor data outputted from the delay processing section; and a log control section controlling storage of the sensor data into the log memories based upon the error signal.

8. The apparatus diagnosis module according to claim 7,
further comprising: a diagnosing section inputted with a control signal outputted from the control board thereto, detecting the error occurrence at the control apparatus and the control board, and outputting the error signal,
wherein the sensor link section, which is inputted with the error signal outputted from the diagnosing section and the sensor data thereto, collects the sensor data in association with the error signal.

9. An apparatus mounted with an apparatus diagnosis module, the apparatus comprising the control board mounted with the apparatus diagnosis module according to claim 7, and the control apparatus controlled by the control board.
